(19) United States
(12) Patent Application Publication
(10) Pub. No.: US 2025/0027543 A1
(43) Pub. Date: Jan. 23, 2025

(54) FLOATING-CALLIPER BRAKE

(71) Applicant: ZF Active Safety GmbH, Koblenz (DE)

(72) Inventors: Yannick Rollin, Limburg an der Lahn (DE); Rainer Lewenz, Kamp-Bornhofen (DE)

(21) Appl. No.: 18/775,399

(22) Filed: Jul. 17, 2024

(30) Foreign Application Priority Data
Jul. 18, 2023 (DE) 102023118912.3

(51) Int. Cl. F16D 55/226; B60T 13/74; F16D 121/04; F16D 121/24

(52) U.S. Cl. CPC F16D 55/2262; B60T 13/745; F16D 2121/04; F16D 2121/24

(57) ABSTRACT

The disclosure relates to a floating-calliper brake a piston region is situated on a brake disc first side, in an axial direction, that can be accommodated in a brake disc chamber, and a finger region is situated on a brake disc second side. A first guide assembly is arranged on a third side running congruently with a brake disc rotational axis that can be accommodated in the chamber and extends along a first guide axis running in the axial direction and parallel to the rotational axis. A second guide assembly is arranged on a fourth side, opposite the third side and extends along a second guide axis running in the axial direction and parallel to the rotational axis. The first guide assembly has a first guide duct enclosed by the brake carrier, a first guide element is guided displaceably in the axial direction in the first guide duct and has a first guide shaft and a first fastening end, and only one first connecting portion that is connected to the floating calliper. The first guide element is fixedly connected to the first connecting portion by its first fastening end. The first connecting portion is situated at the level of the finger region in the axial direction and/or at least partially on the second side.

### CROSS-REFERENCE TO RELATED APPLICATIONS

This application claims priority to German Application No. 102023118912.3, filed on Jul. 18, 2023, the disclosure of which is incorporated herein by reference in its entirety.

### TECHNICAL FIELD

The disclosure relates to an electromechanically operated floating-calliper brake for motor vehicles, in particular passenger cars. The disclosure also relates to an electromechanically driven motor vehicle having such a floating-calliper brake.

### BACKGROUND

Electromechanically operated floating-calliper brakes include both floating-calliper brakes that are exclusively operated electromechanically and floating-calliper brakes that are operated hydraulically and additionally electromechanically. The second case is known in a brake that is actuated hydraulically during driving operation and is actuated electromechanically to secure the position of the vehicle in question. In the case of a floating-calliper brake operated exclusively electromechanically, the actuator piston is actuated by an electric motor and in most cases in combination with a gearing assembly. In the case of the combined solution, the actuator piston can be moved both hydrostatically and by the electric motor and the gearing assembly.

Floating-calliper brakes are commonly designed as fist-type floating-calliper brakes in which the floating calliper is fist-shaped. The fist-type calliper mounted in an axially floating manner has a piston region and a finger region. The brake disc and the brake pads are arranged inside the “fist”, between the finger region and the piston region. An inner region of the fist together with the brake carrier forms a chamber in this region, in which the brake disc is positioned when installed in a motor vehicle. The floating calliper is mounted in an axially displaceable manner relative to the brake carrier.

Electromechanical drives take up more installation space than hydraulic drives. They generally also have a higher weight than hydraulic drives. However, the installation space available in the region of the wheel rim and the wheel mount or wheel suspension is limited. There is also a trend towards having to accommodate further components such as brake covers or brake dust collectors in the region of the floating-calliper brakes. If a powerful floating-calliper brake is required, as is generally the case for front wheel brakes or relatively large passenger cars, the problems of high bearing forces between the brake carrier and the floating calliper also arise (for example with electromechanical units that protrude a lot). In connection with the development of purely electromechanically driven passenger cars, there is an increasing requirement for the wheel brakes also to be operated purely electromechanically. The range of use of hydraulic actuation is thus also declining in brakes that must achieve high braking power.

Therefore, what is needed is to be able to provide a powerful electromechanically operated floating-calliper brake that is suitable e.g. for front wheel brakes and/or for large passenger cars, e.g. SUVs, and is optimized in terms of installation space to the extent that it can be installed better in the region of the wheel rim and the wheel mount or wheel suspension.

### SUMMARY

A floating-calliper brake is proposed herein. In addition, an electromechanically driven motor vehicle having a floating-calliper brake is also disclosed herein.

In one exemplary arrangement, the floating-calliper brake comprises at least one actuator piston for displacing at least one brake pad unit, at least one electromechanical drive for actuating the actuator piston, a brake carrier, and a floating calliper. The floating calliper has a piston region and a finger region. The floating-calliper brake extends in an axial direction such that the piston region is on a first side of a brake disc that can be accommodated in a chamber formed by the brake carrier and the floating calliper, and that the finger region is on a second side, opposite the first side, of the brake disc that can be accommodated in the chamber. The expression “in the axial direction” relates to the orientation of the rotational axis of an associated brake disc that rotates about the rotational axis when installed in the floating-calliper brake and during driving operation of an associated motor vehicle. I.e., “in the axial direction” means parallel to the rotational axis or running along the rotational axis.

A first guide assembly is arranged on a third side at a distance from a centre plane running congruently with the rotational axis of the brake disc that can be accommodated in the chamber. The first guide assembly extends along a first guide axis running in the axial direction and parallel to the rotational axis.

A second guide assembly is arranged on a fourth side, opposite the third side in relation to the centre plane, at a distance from the centre plane and extends along a second guide axis running in the axial direction and parallel to the rotational axis. The first guide assembly has a first guide duct enclosed by the brake carrier, a first guide element that is guided displaceably in the axial direction in the first guide duct and has a first guide shaft and a first fastening end, and only one first connecting portion that is connected, for example, integrally, to the floating calliper. The first guide element is fixedly connected to the first connecting portion by its first fastening end. This connection may be a screw connection. The first connecting portion is at the level of the finger region in the axial direction. The connecting portion can also be situated at least partially on the second side. It is also possible for the two aforementioned positions of the first connecting portion to be present at the same time. The design according to the disclosure that the first guide assembly only has one connecting portion connected to the floating calliper, i.e., the first connecting portion, at the position mentioned, results in a design of the floating-calliper brake that is optimized in terms of installation space.

In one exemplary arrangement, a first installation space is available adjacent to the first guide assembly on the first side in the alignment of the first guide axis. The first installation space can also be available at the level of the piston region in the axial direction. It is also possible for the two aforementioned positions of the first installation space to be present at the same time. This installation space results from interaction with the arrangement of the single first connecting portion.

In one exemplary arrangement, an electric motor is arranged at least partially in the first installation space. The electric motor is used to actuate the actuator piston. A gearbox can also be arranged at least partially in the first installation space. A housing of an electromechanical drive can also be arranged at least partially in the first installation space. In one exemplary arrangement, the electric motor and gearbox cooperate as an electromechanical drive with which the actuator piston can be actuated. The gearbox may be connected between the electric motor and the actuator piston. An electronic control unit can also be positioned at least partially in the first installation space. Such an electronic control unit can be designed to control the electric motor that actuates the actuator piston. Such an electronic control unit can comprise a PCB, electronic components, and a CPU. An electrical interface can also be arranged in the first installation space. Such an electrical interface can be designed to couple data lines or control lines or to couple power supply lines. It can also be designed to couple data lines, control lines and power supply lines. The interface can be in the form of a plug or socket.

Parts or part-regions of a brake cover can also be arranged in the first installation space. Parts or part-regions of a brake dust collection device can also be arranged in the first installation space. It is also possible for several of the aforementioned components or assemblies to be arranged at least partially in the first installation space. The advantage of this is the full utilization of the first installation space. The components for powerful brakes can thus also be positioned close to the floating calliper. This has a favourable effect on the bearing forces (lever length is shortened). Overall, this also allows the necessary parts to be accommodated in the region of the wheel rim and the wheel mount or wheel suspension.

In one exemplary arrangement, the floating-calliper brake comprises a brake cover, which is fastened to the floating calliper by the first fastening end. The brake cover can also be fastened to the first fastening end or to the first connecting portion. The brake cover can also be fastened both to the first fastening end and to the first connecting portion. In one exemplary arrangement, the brake cover has a first retaining portion, which is clamped between the first connecting portion and the first fastening end. The first fastening end can comprise a screw with which the first retaining portion is fixed against the first connecting portion. The first retaining portion may have a passage through which a screw runs for this purpose. By the aforementioned possibilities of fastening the brake cover, a design of the floating-calliper brake is achieved that is optimized in terms of installation space. In this case, the fastening components for coupling the brake calliper and the brake carrier are also used at the same time for fastening the brake cover. This saves installation space and is an economical solution. It also allows an aesthetically appealing design of the brake cover. Such a brake cover can be a protective cover, a logo plate or part of a brake dust collection device. It can also be a stabilization plate. Several or all of the aforementioned functions can be implemented in the brake cover.

In one exemplary arrangement, the first guide duct has a first and a second end and extends between these ends along the first guide axis, wherein the first end is arranged closer to the piston region than to the finger region in the axial direction, and wherein the second end is arranged closer to the finger region than to the piston region in the axial direction, wherein the first end is closed and the second end is open, and wherein the first guide element protrudes with its guide shaft, i.e., with the first guide shaft, through the opening of the second end into the first guide duct.

In one exemplary arrangement of the floating-calliper brake according to the disclosure, the second guide assembly has a second guide duct enclosed by the brake carrier, a second guide element that is guided displaceably in the axial direction in the second guide duct and has a second guide shaft and a second fastening end, and only one second connecting portion that is connected, for example, integrally, to the floating calliper. In this exemplary arrangement of the floating-calliper brake, the second guide element is fixedly connected, for example, screw-fastened, to the second connecting portion by its fastening end. The second connecting portion is situated at the level of the piston region in the axial direction or at least partially on the first side. It is also possible for the two aforementioned positions of the second connecting portion to be present at the same time. This exemplary arrangement of the floating-calliper brake results in a suitable transmission of force between the brake carrier and the floating calliper. I.e., the greater weight of the electromechanical drive is thus supported in a suitable manner and dissipated via the first and second guide assemblies such that comparatively low stresses resulting from effective forces occur in the relevant components.

In one exemplary arrangement, the second guide duct has a third and a fourth end and extends between these ends along the second guide axis, wherein the third end is arranged closer to the piston region than to the finger region in the axial direction, and wherein the second end is arranged closer to the finger region than to the piston region in the axial direction, wherein the third end is open and the fourth end is closed, and wherein the second guide element protrudes with its guide shaft, i.e., with the second guide shaft, through the opening of the third end into the second guide duct.

In a further exemplary arrangement of the floating-calliper brake according to the disclosure, the second guide assembly has a second guide duct enclosed by the brake carrier, a second guide element that is guided displaceably in the axial direction in the second guide duct and has a second guide shaft and a second fastening end, and only one second connecting portion that is connected, for example, integrally, to the floating calliper. In this exemplary arrangement of the floating-calliper brake, the second guide element is fixedly connected, such as screw-fastened, to the second connecting portion by its fastening end, i.e., the second fastening end. The second connecting portion is situated at the level of the finger region in the axial direction or at least partially on the second side. It is also possible for the two aforementioned positions of the second connecting portion to be present at the same time. This exemplary arrangement that the first guide assembly has only one connecting portion connected to the floating calliper, i.e., the first connecting portion, at the aforementioned position, and that the second guide assembly has only one connecting portion connected to the floating calliper, i.e., the second connecting portion, at the aforementioned position, results in an extended design of the floating-calliper brake that is optimized in terms of installation space.

A second installation space may be available adjacent to the second guide assembly on the first side in the alignment of the second guide axis. The second installation space can also be available at the level of the piston region in the alignment of the second guide axis in the axial direction. It is also possible for the two aforementioned positions of the second installation space to be present at the same time. This installation space results from interaction with the arrangement of the single second connecting portion.

An electric motor may be arranged at least partially in the second installation space. The electric motor is used to actuate the actuator piston. A gearbox can also be arranged at least partially in the second installation space. A housing of an electromechanical drive can also be arranged at least partially in the second installation space. The electric motor and gearbox may be configured to cooperate as an electromechanical drive with which the actuator piston can be actuated. In one exemplary arrangement, the gearbox is connected between the electric motor and the actuator piston. An electronic control unit can also be positioned at least partially in the first installation space. Such an electronic control unit can be designed to control the electric motor that actuates the actuator piston. Such an electronic control unit can comprise a PCB, electronic components, and a CPU. An electrical interface can also be arranged in the first installation space. Such an electrical interface can be designed to couple data lines or control lines or to couple power supply lines. It can also be designed to couple data lines, control lines and power supply lines. The interface can be in the form of a plug or socket. Parts or part-regions of a brake cover can also be arranged in the second installation space. Parts or part-regions of a brake dust collection device can also be arranged in the second installation space. It is also possible for several of the aforementioned components or assemblies to be arranged at least partially in the second installation space. The advantage of this is the full utilization of the second installation space. The components for powerful brakes can thus also be positioned close to the floating calliper. This has a favourable effect on the bearing forces (lever length is shortened). Overall, this also allows the necessary parts to be accommodated in the region of the wheel rim and the wheel mount or wheel suspension.

The aforementioned brake cover or a further brake cover may be fastened to the floating calliper by the second fastening end. The brake cover can also be fastened to the second fastening end or to the second connecting portion. The brake cover can also be fastened both to the second fastening end and to the second connecting portion. In one exemplary arrangement, the brake cover has a second retaining portion, which is clamped between the second connecting portion and the second fastening end. The second fastening end can comprise a screw with which the second retaining portion is fixed against the second connecting portion. The second retaining portion may have a passage through which a screw runs for this purpose. The effects of these fastening possibilities are the same as those that have already been mentioned above in relation to the fastening of the brake cover to or with the first fastening end and the first connecting portion.

The electromechanically driven motor vehicle according to the disclosure comprises a floating-calliper brake as described above. The design of the floating-calliper brake can have individual described aspects of the disclosure or else a combination of the above-described aspects of the disclosure. Such an electromechanically driven vehicle having the floating-calliper brake according to the disclosure results in a design optimized in terms of installation space. In connection with large wheel rim diameters, the advantage of a compact arrangement of the components in the axial direction is achieved, among other things, which also has an advantageous effect in terms of force on the first and second guide assemblies.

### BRIEF DESCRIPTION OF THE DRAWINGS

Further features, advantages and application possibilities of the present disclosure can be found in the following description of the exemplary arrangements and the schematic drawings. For the sake of clarity, not all the elements shown in a drawing are also provided with a reference sign. However, corresponding elements or regions are then labelled in at least one other drawing, and the meaning can be found there. In addition, the same reference signs can stand for the same or similar objects in the drawings.

FIG. 1 shows a schematic diagram of an exemplary arrangement of a floating-calliper brake according to the disclosure,

FIG. 2 shows a schematic diagram of a further exemplary arrangement of a floating-calliper brake according to the disclosure,

FIG. 3 shows a schematic diagram of a floating-calliper brake according to the disclosure with advantageous design features, and

FIG. 4 shows a schematic diagram of a motor vehicle according to the disclosure.

### DETAILED DESCRIPTION

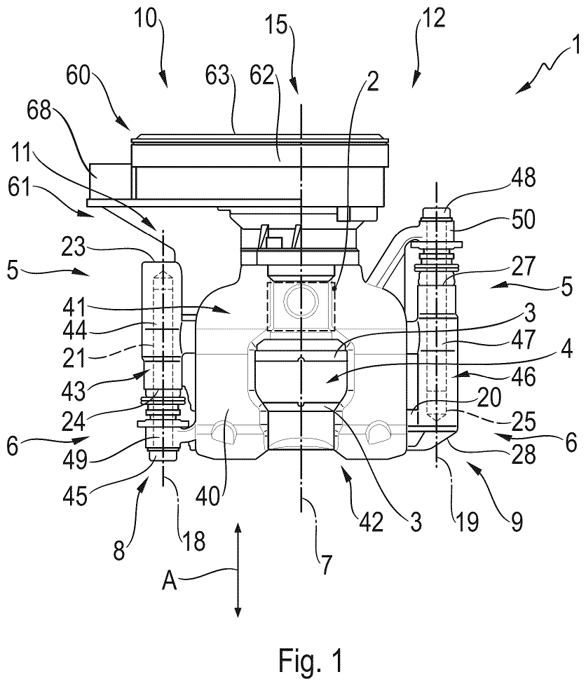

In a first exemplary arrangement of the floating-calliper brake 1 according to the disclosure, it is shown in FIG. 1 that a floating calliper 40 is mounted displaceably in an axial direction A relative to a brake carrier 20 by a first guide assembly 8 and a second guide assembly 9. The floating calliper 40 has a finger region 42 and a piston region 41. In the connection region between the finger region 42 and the piston region 41, the floating calliper 40 has a hollow area on its inner side. The brake carrier 20 also has a cavity in this region. These hollow area/cavities together form a chamber 4, which is used to accommodate a brake disc. During operation of the floating-calliper brake 1 and when the floating-calliper brake 1 is installed in a motor vehicle, a brake disc can rotate in the chamber 4 about a rotational axis 7.

In the present case, the side of an installed brake disc in the mounted state that is oriented towards the finger region 42 or situated in the vicinity thereof is defined as a second side 6. In the present case, the side of an installed brake disc in the mounted state that is oriented towards the piston region 41 or situated in the vicinity thereof is defined as a first side 5. The rotational axis 7 defines an axial direction A, which runs along or parallel to the rotational axis 7. The plane running congruently with the rotational axis 7 is defined as the centre plane 15 in the present case. The centre plane 15 separates a third side 10 from a fourth side 12.

Two mutually opposing brake pad units 3 are arranged in the chamber 4 such that the brake disc can rotate between them and the brake pad units 3 can brake the brake disc when the floating-calliper brake 1 is actuated. An actuator piston 2 is accommodated in the piston region 41 of the floating calliper 40, is displaced in the axial direction A when the floating-calliper brake 1 is actuated, and causes the brake pad units 3 to be pressed against the brake disc. For this purpose, the floating calliper 40 is mounted in an axially displaceable manner relative to the brake carrier 20. The actuator piston 2 is shown schematically with a dashed line. An electromechanical drive 60 is attached to the floating calliper 40 in the piston region 41. The electromechanical drive 60 comprises a housing 63, a gearbox 62 installed in the housing 63, an electric motor 61, and an electrical interface 68 in the form of a plug socket. Depending on the application, the electrical interface 68 of the floating-calliper brake 1 can be in the form of a plug socket or a plug. Only part of the electric motor 61 can be seen. The floating calliper 40 has a first connecting portion 49 on the third side 10 in the finger region 42. The first connecting portion 49 is fixedly connected to the floating calliper 40 since it is the same cast part. The first connecting portion 49 protrudes somewhat from the floating calliper 40, away from the centre plane 15.

The first guide assembly 8 is situated on the third side 10 at a distance from the centre plane 15 and comprises a first guide duct 21, which is made in a part of the brake carrier 20 and extends along a first guide axis 18 in the axial direction A between a first end 23 and a second end 24. The first guide duct 21 is closed at the first end 23 and open at the second end 24. The first end 23 of the first guide duct 21 is situated on the second side 6, i.e., at the level of the finger region 42 as viewed in the axial direction A, and the second end 24 is situated on the first side 5, i.e., at the level of the piston region 41. The first guide assembly 8 also comprises a first guide element 43 with a first guide shaft 44 and a first fastening end 45. The first guide element 43 is fixedly connected to the first connecting portion 49 by its fastening end 45. A screw protrudes through the first connecting portion 49 and is screw-fastened to the first fastening end 45.

The first guide element 43 is accommodated in a displaceably mounted manner with its guide shaft 44 in the first guide duct 21. The open second end 24 of the first guide duct 21 is sealed by a schematically shown rubber sleeve, which is fastened to the second end 24 of the first guide duct 21 and to the first guide element 43. A first installation space 11 is situated in the alignment of the first guide axis 18, following the second end 24 of the first guide duct 21 as seen from the second side towards the first side. Said installation space is defined by the arrangement of the first connecting portion 49 and the described manner in which the first guide element 43 is fastened to the first connecting portion 49 and is introduced into the first guide duct 21.

A part of the electromechanical drive 60 with the housing 63, electric motor 61 and gearbox 62 is arranged in the first installation space 11. An electrical interface 68 is arranged in the first installation space 11 or in the vicinity thereof.

The second guide assembly 9 is situated on the fourth side 12 at a distance from the centre plane 15 and comprises a second guide duct 25, which is made in a further part of the brake carrier 20 and extends along a second guide axis 19 in the axial direction A between a third end 27 and a fourth end 28. The second guide duct 25 is closed at the fourth end 28 and open at the third end 27. The fourth end 28 of the second guide duct 25 is situated on the second side 6, i.e., at the level of the finger region 42 as viewed in the axial direction A, and the third end 27 is situated on the first side 5, i.e., at the level of the piston region 41. The second guide assembly 9 also comprises a second guide element 46 with a second guide shaft 47 and a second fastening end 48. The second guide element 46 is fixedly connected to the second connecting portion 50 by its fastening end 48. This second connecting portion 50 is fixedly connected to the floating calliper 40 on the fourth side 12 in the piston region 41, since it is the same cast part. The second connecting portion 50 protrudes somewhat from the floating calliper 40, away from the centre plane 15 and from the chamber 4. A screw protrudes through the second connecting portion 50 and is screw-fastened to the second fastening end 48. The second guide element 46 is accommodated in a displaceably mounted manner with its guide shaft 47 in the second guide duct 25. The open third end 27 of the second guide duct 25 is sealed by a schematically shown rubber sleeve, which is fastened to the third end 27 of the second guide duct 25 and to the second guide element 46.

In the view shown in FIG. 1, the first and second connecting portions 49, 50 are arranged diagonally to one another, in a manner of speaking. It could also be said that the two guide assemblies 8, 9 are arranged inverted through a point relative to one another, at least in terms of the direction in which the guide elements 43, 46 penetrate the guide ducts 21, 25. In this case, the point of inversion lies on the centre plane 15 and in the region of the chamber 4 or between the chamber 4 and the piston region 41. The first and second guide axes 18, 19 lie in the same plane. The described structure allows installation space to be gained and optimized while forces and moments are transmitted suitably between the floating calliper 40 and the brake carrier 20. Parts of the gearbox 62 and of the relevant housing 63 are arranged in the first installation space 11. These components are thereby arranged comparatively close in the axial direction to the mount of the floating calliper 40, as a result of which moments and forces in the mount and material stresses in the corresponding components are reduced.

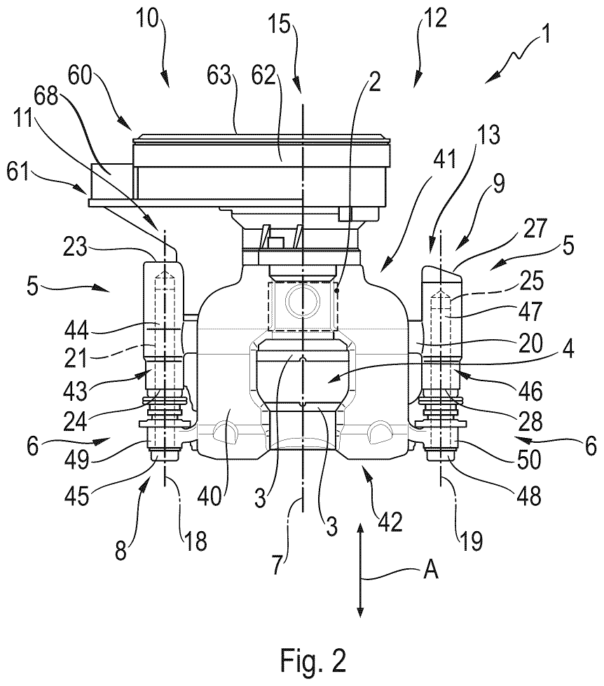

A second exemplary arrangement of the floating-calliper brake 1 according to the disclosure, which is shown in FIG. 2, differs from the first exemplary arrangement only in the second guide assembly 9. For this reason, only the differences are discussed below. Where the general structure of the floating-calliper brake 1 and the first guide assembly 8 are concerned, reference is made to the corresponding statements relating to the first exemplary arrangement.

In the second exemplary arrangement according to FIG. 2, the second guide assembly 9 is likewise situated on the fourth side 12 at a distance from the centre plane 15 and comprises a second guide duct 25, which is made in a further part of the brake carrier 20 and extends along a second guide axis 19 in the axial direction A between a third end 27 and a fourth end 28. The second guide duct 25 is open at the fourth end 28 and closed at the third end 27. The fourth end 28 of the second guide duct 25 is situated on the second side 6, i.e., at the level of the finger region 42 as viewed in the axial direction A, and the third end 27 is situated on the first side 5, i.e., at the level of the piston region 41. The second guide assembly 9 also comprises a second guide element 46 with a second guide shaft 47 and a second fastening end 48. The second guide element 46 is fixedly connected to the second connecting portion 50 by means of its fastening end 48. This second connecting portion 50 is fixedly connected to the floating calliper 40 on the fourth side 12 in the finger region 42, since it is the same cast part. The second connecting portion 50 protrudes somewhat from the floating calliper 40, away from the centre plane 15. A screw protrudes through the second connecting portion 50 and is screw-fastened to the second fastening end 48. The second guide element 46 is accommodated in a displaceably mounted manner with its guide shaft 47 in the second guide duct 25. The open fourth end 28 of the second guide duct 25 is sealed by a rubber sleeve, which is fastened to the fourth end 28 of the second guide duct 25 and to the second guide element 46. In the view shown in FIG. 2, the first and second connecting portions 49, 50 are arranged mirror-symmetrically to one another in relation to the centre plane 15, in a manner of speaking. The first and second guide axes 18, 19 lie in the same plane. On the first side, there is a first and second installation space both on the third and on the fourth side, in the alignment of the first and the second guide axis 18, 19, respectively, in the piston region. Because of these two installation spaces, components (e.g. cover plates, dust collectors) can again be positioned close to the mount (mount of the floating calliper), as a result of which installation space is optimized overall, and moments and forces in the mount and material stresses in the corresponding components are reduced.

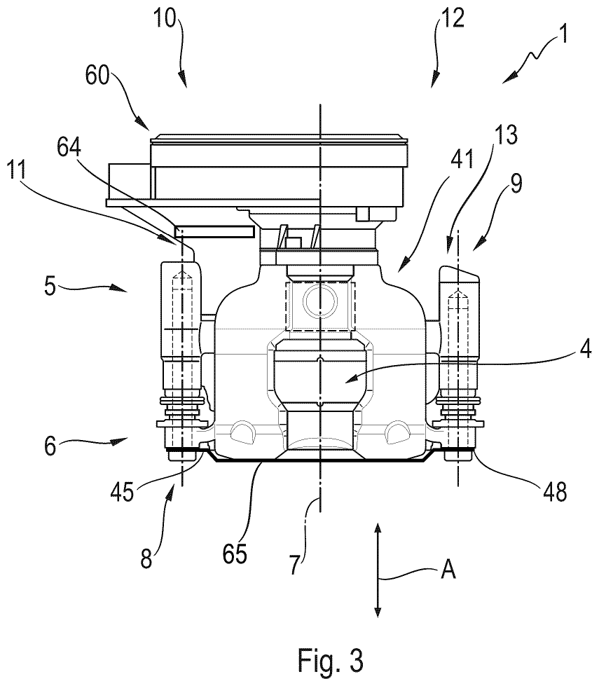

In FIG. 3, it is shown schematically by a rectangle that an electronic control unit 64 is installed in the first installation space 11. Many reference signs have been omitted from FIG. 3 for the sake of clarity. However, the corresponding reference signs that are not shown can be found in FIG. 2. The electronic control unit 64 can comprise a PCB with corresponding electronic components and a CPU. It is self-evident that this electronic control unit 64 can also be installed in the second installation space 13 or that it extends over both installation spaces 11 and 13. The combination with a housing 63 in which the electronic control unit 64 is installed is particularly advantageous. In the course of the electrification of floating-calliper brakes, for example, also in powerful brakes, water- and dust-protected housings are provided, which can also be used for housing an electrical control system and the components thereof, which likewise results in an optimization of installation space.

In FIG. 3, a brake cover 65 is also present on the second side 6. This brake cover 65 covers, inter alia, the fingers of the floating calliper 40. The brake cover 65 has retaining portions 66, 67 on its outer ends extending away from the centre plane 15. The first retaining portion 66 is fixed between a screw of the first fastening end 45 of the first guide element 43 and the first connecting portion 49 of the floating calliper 40. The second retaining portion 67 is fixed between a screw of the second fastening end 48 of the second guide element 46 and the second connecting portion 50 of the floating calliper 40. This type of fastening of the brake cover 65 is an advantageous design in terms of installation space.

The features of the disclosure shown in FIG. 3 and described in the paragraphs above are of course also combinable and compatible with the exemplary arrangement of the disclosure shown in FIG. 1.

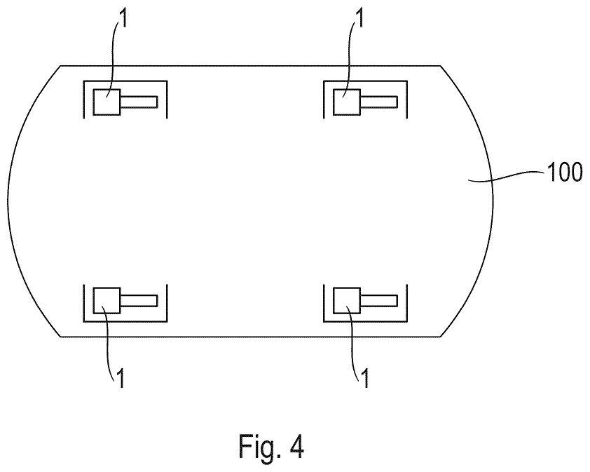

FIG. 4 shows a schematic diagram of a motor vehicle 100 according to the disclosure. The motor vehicle 100 comprises a floating-calliper brake 1 according to one or more of the aforementioned features of the disclosure on each of its four wheels. Thanks to the high braking power that can be achieved, the floating-calliper brake 1 according to the disclosure is suitable both for rear wheels and for front wheels.

1. A floating-calliper brake comprising:
at least one actuator piston for displacing at least one brake pad unit, at least one electromechanical drive for actuating the actuator piston, a brake carrier, and a floating calliper,
wherein the floating calliper has a piston region and a finger region,
wherein the floating-calliper brake extends in the axial direction such that the piston region is on a first side of a brake disc that can be accommodated in a chamber formed by the brake carrier and the floating calliper, and that the finger region is on a second side, opposite the first side, of the brake disc that can be accommodated in the chamber,
wherein a first guide assembly is arranged on a third side at a distance from a centre plane running congruently with the rotational axis of the brake disc that can be accommodated in the chamber and extends along a first guide axis running in the axial direction and parallel to the rotational axis,
wherein a second guide assembly is arranged on a fourth side, opposite the third side in relation to the centre plane, at a distance from the centre plane and extends along a second guide axis running in the axial direction and parallel to the rotational axis,
wherein the first guide assembly has comprises
a first guide duct enclosed by the brake carrier,
a first guide element that is guided displaceably in the axial direction in the first guide duct and has a first guide shaft and a first fastening end,
and only one first connecting portion that is connected to the floating calliper,
wherein the first guide element is fixedly connected to the first connecting portion by means of its first fastening end,
wherein the first connecting portion is situated at the level of the finger region in the axial direction and/or at least partially on the second side.

2. The floating-calliper brake according to claim 1,
wherein a first installation space is available adjacent to the first guide assembly on the first side and/or at the level of the piston region in the axial direction in an alignment of the first guide axis.

3. The floating-calliper brake according to claim 2, wherein at least part of an electric motor for actuating the actuator piston, are arranged in the first installation space.

4. The floating-calliper brake according to claim 1, wherein the floating-calliper brake comprises a brake cover, which is fastened to the floating calliper by the first fastening end.

5. The floating-calliper brake according to claim 1,
wherein the first guide duct has a first and a second end and extends between these ends along the first guide axis, wherein the first end is arranged closer to the piston region than to the finger region in the axial direction, and wherein the second end is arranged closer to the finger region than to the piston region in the axial direction, wherein the first end is closed and the second end is open, and wherein the first guide element protrudes with its guide shaft through the opening of the second end into the first guide duct.

6. The floating-calliper brake according to claim 1,
wherein the second guide assembly has
a second guide duct enclosed by the brake carrier,
a second guide element that is guided displaceably in the axial direction in the second guide duct and has a second guide shaft and a second fastening end,
and only one second connecting portion that is connected to the floating calliper,
wherein the second guide element is fixedly connected to the second connecting portion by its second fastening end,
wherein the second connecting portion is situated at a level of the piston region in the axial direction and/or at least partially on the first side.

7. The floating-calliper brake according to claim 6,
wherein the second guide duct has a third and a fourth end and extends between these ends along the second guide axis, wherein the third end is arranged closer to the piston region than to the finger region in the axial direction, and wherein the second end is arranged closer to the finger region than to the piston region in the axial direction, wherein the third end is open and the fourth end is closed, and wherein the second guide element protrudes with its guide shaft through the opening of the third end into the second guide duct.

8. The floating-calliper brake according to claim 1,
wherein the second guide assembly has
a second guide duct enclosed by the brake carrier,
a second guide element that is guided displaceably in the axial direction in the second guide duct and has a second guide shaft and a second fastening end,
and only one second connecting portion that is connected, in particular integrally, to the floating calliper,
wherein the second guide element is fixedly connected to the second connecting portion by its second fastening end,
wherein the second connecting portion is situated at the level of the finger region in the axial direction and/or at least partially on the second side.

9. The floating-calliper brake according to claim 8,
wherein a second installation space is available adjacent to the second guide assembly on the first side and/or at the level of the piston region in the axial direction in the alignment of the second guide axis.

10. The floating-calliper brake according to claim 9, wherein at least part of an electric motor for actuating the actuator piston, and/or at least part of a gearbox are arranged in the second installation space.

11. The floating-calliper brake according to claim 8, wherein the floating-calliper brake comprises a brake cover, which is fastened by the second fastening end and/or to the second fastening end.

12. An electromechanically driven motor vehicle comprising a floating-calliper brake according to claim 1.

13. The floating-calliper brake according to claim 2, wherein at least part of a gearbox and/or at least part of a housing of an electromechanical drive are arranged in the first installation space.

14. The floating-calliper brake according to claim 2, wherein at least part of an electronic control unit for controlling an electric motor for actuating the actuator piston, and/or an electrical interface and/or parts or part-regions of a brake dust collection device are arranged in the first installation space.

15. The floating-calliper brake according to claim 1, wherein the floating-calliper brake comprises a brake cover, which is fastened to the floating calliper to the first connecting portion.

16. The floating-calliper brake according to claim 9, wherein at least part of a housing of an electromechanical drive and/or at least part of an electronic control unit for controlling an electric motor for actuating the actuator piston, and/or an electrical interface are arranged in the second installation space.

17. The floating-calliper brake according to claim 9, wherein parts or part-regions of a brake cover and/or parts or part-regions of a brake dust collection device are arranged in the second installation space.

18. The floating-calliper brake according to claim 8, wherein the floating-calliper brake comprises a brake cover, which is fastened to the second connecting portion and clamped with a second retaining portion between the second connecting portion and the second fastening end.
